(19) United States
(12) Patent Application Publication
(10) Pub. No.: US 2020/0367322 A1
(43) Pub. Date: Nov. 19, 2020

(54) Surface Heating Assembly and Related Methods

(71) Applicant: Schluter Systems L.P., Plattsburgh, NY (US)

(72) Inventor: Gilles Gagnon, Ste-Therese (CA)

(21) Appl. No.: 16/412,289

(22) Filed: May 14, 2019

(51) Int. Cl. H05B 3/56; H05B 3/14

(52) U.S. Cl. CPC H05B 3/56; H05B 2203/02; H05B 2203/026; H05B 3/146

(57) ABSTRACT

A heating cable installation includes a heating cable having a first metallic conductor and at least a second metallic conductor, spaced from and extending substantially parallel to the first metallic conductor. A PTC (positive temperature coefficient) matrix is electrically coupled about the first and second metallic conductors. A compressible insulator is disposed about the PTC matrix, the compressible insulator being compressible to allow thermal expansion of the PTC matrix. A rigid, outer encasement material prevents outward expansion of the heating cable.

### BACKGROUND OF THE INVENTION

### Field of the Invention

The present invention relates generally to heating cable sets. More particularly, the present technology relates to heating cable sets used in electrical floor or surface heating systems, such as those installed in or beneath concrete surfaces and beneath floor covering applications such as ceramic tiles, stone, wood, etc.

### Related Art

Electrical heating cable sets can be installed beneath traditional flooring applications to warm the floor from beneath. Where such cables are parallel heating cables, and more specifically of the self-regulating type, the cables generally include a positive temperature coefficient (or “PTC”) material between two buss conductors. When a voltage is applied between the two buss conductors, an electrical current flows through the PTC material, which will increase its temperature and by its nature, will expand as it heats. This expansion causes the electrical resistance of the PTC material to increase as it gets warmer: thus decreasing the electrical current and power through the cable, and thus reducing the rate at which it continues to warm as it expands. This nature of such material makes it ideal for self-regulating purposes.

In many flooring applications, however, the cable is embedded in a rigid material, such as concrete or thin set or mortar, which impedes the expansion of the PTC material. This results in less than optimal performance of the PTC material.

### SUMMARY OF THE INVENTION

In accordance with one aspect of the technology, a heating cable is provided, including a first metallic conductor and at least a second metallic conductor, spaced from and extending substantially parallel to the first metallic conductor. A PTC (positive temperature coefficient) matrix can be electrically coupled about the first and second metallic conductors. A compressible insulator can be disposed about the PTC matrix, the compressible insulator being compressible to allow thermal expansion of the PTC matrix. An outer insulating layer can be disposed about the compressible insulator.

In accordance with another aspect of the technology, a heating cable installation is provided, including a heating cable having a first metallic conductor and at least a second metallic conductor, spaced from and extending substantially parallel to the first metallic conductor. A PTC (positive temperature coefficient) matrix can be electrically coupled about the first and second metallic conductors. A compressible insulator can be disposed about the PTC matrix, the compressible insulator being compressible to allow thermal expansion of the PTC matrix. A rigid, outer encasement material, can be disposed about the compressible insulator to prevent outward expansion of the heating cable.

In accordance with another aspect of the technology, a method of installing a heating cable is provided, including: obtaining a heating cable having a first metallic conductor and at least a second metallic conductor, spaced from and extending substantially parallel to the first metallic conductor, a PTC (positive temperature coefficient) matrix electrically coupled about the first and second metallic conductors and a compressible insulator disposed about the PTC matrix, the compressible insulator being compressible to allow thermal expansion of the PTC matrix. The method can include embedding the heating cable within a rigid, outer encasement material, the outer encasement material preventing outward expansion of the heating cable.

### BRIEF DESCRIPTION OF THE DRAWINGS

The following drawings illustrate exemplary embodiments for carrying out the invention. Like reference numerals refer to like parts in different views or embodiments of the present invention in the drawings. The heating cables shown are generally much longer than the cross-sections shown, extending longitudinally at right angles to the cross-sections shown (e.g., into and out of the plane of the figure).

FIG. 1 is a cross-sectional view of a heating cable installation in accordance with an aspect of the technology;

FIG. 2 is a cross-sectional view of another heating cable in accordance with an aspect of the technology;

FIG. 3 is a cross-sectional view of another heating cable in accordance with an aspect of the technology;

FIG. 4 is a cross-sectional view of another heating cable in accordance with an aspect of the technology;

FIG. 5 is a cross-sectional view of another heating cable in accordance with an aspect of the technology;

FIG. 6 is a cross-sectional view of another heating cable in accordance with an aspect of the technology;

FIG. 7 is a cross-sectional view of another heating cable in accordance with an aspect of the technology;

FIG. 8 is a cross-sectional view of another heating cable in accordance with an aspect of the technology; and

FIG. 9 is a cross-sectional view of another heating cable in accordance with an aspect of the technology.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Definitions

As used herein, the singular forms “a” and “the” can include plural referents unless the context clearly dictates otherwise. Thus, for example, reference to “a conductor” can include one or more of such conductors, if the context so dictates.

As used herein, the term “substantially” refers to the complete or nearly complete extent or degree of an action, characteristic, property, state, structure, item, or result. As an arbitrary example, an object that is “substantially” enclosed is an article that is either completely enclosed or nearly completely enclosed. The exact allowable degree of deviation from absolute completeness may in some cases depend upon the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As another arbitrary example, a composition that is “substantially free of” an ingredient or element may still actually contain such item so long as there is no measurable effect as a result thereof.

As used herein, the term “compressible” is used to refer to components that exhibit an increase in density, or otherwise a decrease in volume, when compressed. This behavior can be expressed by the Poisson's ratio of materials. Incompressible materials generally have a Poisson's ratio of 0.5. In the wire and cable industry, solid polymeric materials generally used have a Poisson's ratio in the range of 0.4 to 0.5, hence they are either incompressible or only slightly compressible under high pressure. When these polymeric materials are foamed during the extrusion process, and their layer becomes a cellular structure, the Poisson's ratio lowers to a range of 0 to 0.3 depending on the percentage of voids in the layer, or otherwise on the percentage of change in the density of the material. At these levels of the Poisson's ratio, the polymeric material is compressible under low to medium pressure.

As used herein, the term “about” is used to provide flexibility to a numerical range endpoint by providing that a given value may be “a little above” or “a little below” the endpoint.

Relative directional terms can sometimes be used herein to describe and claim various components of the present invention. Such terms include, without limitation, “upward,” “downward,” “horizontal,” “vertical,” etc. These terms are generally not intended to be limiting, but are used to most clearly describe and claim the various features of the invention. Where such terms must carry some limitation, they are intended to be limited to usage commonly known and understood by those of ordinary skill in the art in the context of this disclosure. In some instances, dimensional information is included in the figures. This information is intended to be exemplary only, and not limiting. In some cases, the drawings are not to scale and such dimensional information may not be accurately translated throughout the figures.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Invention

The present technology relates generally to systems used beneath floor and/or wall covering installations to warm the covering surface. In such systems, membranes such as those commercially known as Schuter's DITRA-Heat can be secured to a subfloor, after which a heating cable set can be run in a generally repeating back-and-forth pattern and held within securing features of the membrane. Ceramic tiles can then be installed over the membrane and heating cable. As current is applied through the heating cable, the ceramic tiles are heated, creating a pleasantly warmed floor beneath a user's feet. The present technology is also well suited for applications such as ice melting in exterior concrete and similar applications.

Where such cables are self-regulating heating cables, the cables generally include a positive temperature coefficient (or “PTC”) material that, by its nature, expands as it heats. This expansion causes the electrical resistance of the PTC material to increase as it gets warmer: thus decreasing the rate at which it continues to warm as it expands. This nature of such material makes it ideal for self-regulating purposes. In many applications involving heating cables, however, the cable is embedded in a rigid material, such as thin set or mortar, which impedes the expansion of the PTC material. As the PTC is restricted from expanding, it is limited from performing to is maximum potential. However, the rigid material is a necessary component of many flooring and surface installations.

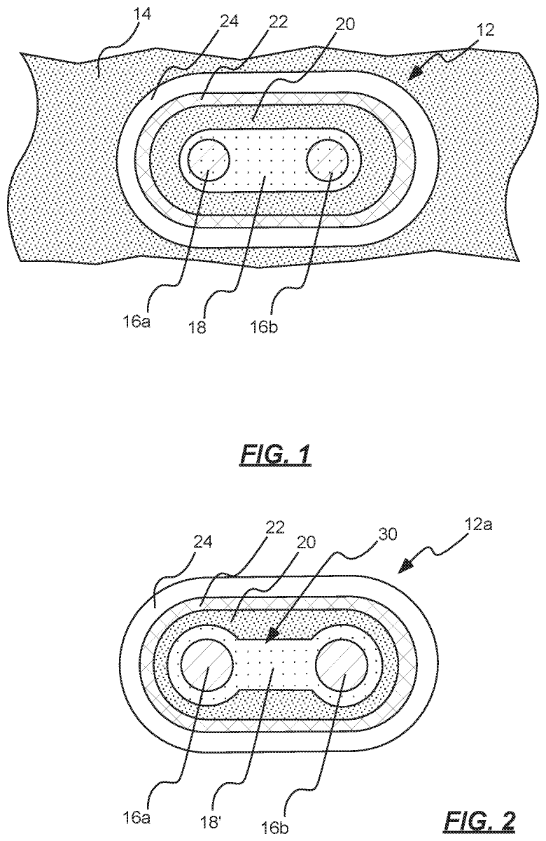

The present technology addresses this tension in a manner that enables a self-regulating heating cable set to be used within a rigid encasement in such a manner that the PTC cable is allowed to expand as needed. One exemplary embodiment of the technology is shown FIG. 1. In this example, a heating cable installation is provided, including a “flat” (e.g., typically having a greater width than a height) self-regulating heating cable 12 at least partially surrounded or encased by a rigid, outer encasement material 14. The outer encasement material can be a cementitious material, such as a mortar or thin set material, as is commonly used in such installations. While the outer encasement material can include a variety of material types, it is typically sufficiently rigid so as to prevent or limit or restrict outward expansion of the heating cable. The outer encasement material can be, for example, a mortar bed in which a heating cable is embedded. While not shown in the figures, the heating cable can be restrained within features of a membrane, such as DITRA-Heat®, and the membrane and heating cable can be buried within the mortar bed.

While not shown in detail, those of ordinary skill in the art will readily appreciate that the heating cables shown will be coupled to a power source and controller. A set point is established with the controller and the heating cable is operated on and off by the controller to heat as necessary to obtain and maintain the desired temperature of the substrate.

The heating cable 12 can include a first metallic conductor 16a and at least a second metallic conductor 16b. The second metallic conductor is generally spaced from and extends substantially parallel to the first metallic conductor. A PTC (positive temperature coefficient) matrix 18 can be electrically coupled about the first and second metallic conductors. The PTC matrix can include a variety of materials, but generally exhibits temperature-dependent electrical resistance and a positive temperature coefficient. In one aspect, the PTC material is a crosslinked plastic doped with carbon particles. This type of plastic has proven to be particularly suitable for such heating applications.

Generally, as current flows through first and second metallic conductors, current also flows through the PTC matrix, causing the PTC matrix to warm. However, as an electrical resistance of the PTC matrix is dependent upon a temperature of the matrix, the rate at which current flows through the matrix varies. Current flows more easily at lower temperatures, and then is restricted as the matrix increases in temperature. It is in this manner that the PTC matrix provides a self-regulating heating cable: once an upper temperature is reached, current flow attains a minimum and the upper temperature is maintained. In addition, the PTC matrix expands as it warms—if this expansion is restricted, the matrix cannot function at peak levels.

To allow for this expansion, a compressible insulator 20 can be disposed about the PTC matrix. The compressible insulator can be formed from a variety of materials, but is generally compressible to allow thermal expansion of the PTC matrix. Thus, even in the event that the rigid, outer encasement material would otherwise prevent or limit or restrict expansion of the PTC matrix, the compressible insulator can instead compress between the PTC matrix and other components of the heating cable to enable the PTC to expand. In this manner, regardless of the material outside of the compressible insulator, the PTC matrix can expand to enable proper functioning of the PTC material. When the cable is allowed to cool, the PTC matrix contracts, as does the compressible insulator.

In testing the present technology, the present inventor has found that the configuration provides an additional reduction in power per degrees Centigrade of cable temperature of between about 35% to about 38%, compared to the prior art. Stated differently, the present technology has resulted in between about 40% to about 46% reduction in power per difference in degrees Centigrade of cable temperature relative to room temperature, when compared to the prior art. As examples, at cable temperatures of 35° C. and 40° C., the input power levels for the cable with the present technology were lower than the prior art by 37% and 38%, respectively. These numbers were generated in a test setup where each cable had temperature sensors (thermocouples) applied directly on the cable outer jacket. The cable utilizing the compressible insulator had a 1/16 inch of foam layer around the cable and over the temperature sensors. Each cable was embedded in self-leveling mortar and tested one week later. As such, the actual cable temperatures and power levels were measured for these comparisons.

The compressible insulator 20 can be formed from a variety of materials. In one aspect, the insulator includes a thermoplastic material. The compressible insulator can include a foamed or cellular polymeric material using crosslinked polyolefins, fluoropolymers and thermoplastic elastomers, and the like. A variety of suitable materials can be used to provide sufficient expansion for the PTC material. In example shown in FIG. 1, the heating cable 12 includes an outer insulating layer 24 disposed about the entirety of the cable. The outer insulating layer can be formed from any suitable material, such as polyolefins, crosslinked polyolefins, fluoropolymers and thermoplastic elastomers. A metallic shield 22, which in some embodiments can be configured as a sheath, can be disposed beneath the outer insulating layer and about the compressible insulator 20. The metallic shield can serve as a ground, and can be configured in a number of manners, as would be appreciated by one of ordinary skill in the art having possession of this disclosure. For example, the metallic shield can be formed from a wire braid in a manner similar to that used in a variety of known cable configurations.

The present cables thus advantageously provide a manner in which expandable self-regulating heating cables can be used in applications that would otherwise restrict the expansion of the self-regulating heating cables.

FIG. 2 illustrates a further embodiment 12a of the invention in which a cross-section of the PTC matrix 18′ includes a reduced section 30. Generally, ends of the matrix conform to the circular cross section of the conductors 16a, 16b, while the reduced section is decreased in height in the area between. By varying the cross-sectional shape or size or area of the PTC matrix, the amount of PTC matrix can be decreased, or increased where desired, to match more closely the diameter of the conductors for instance, while maintaining the appropriate volume resistivity and the common, overall cable configuration. This also results in a corresponding increase in the amount of compressible insulator 20 used.

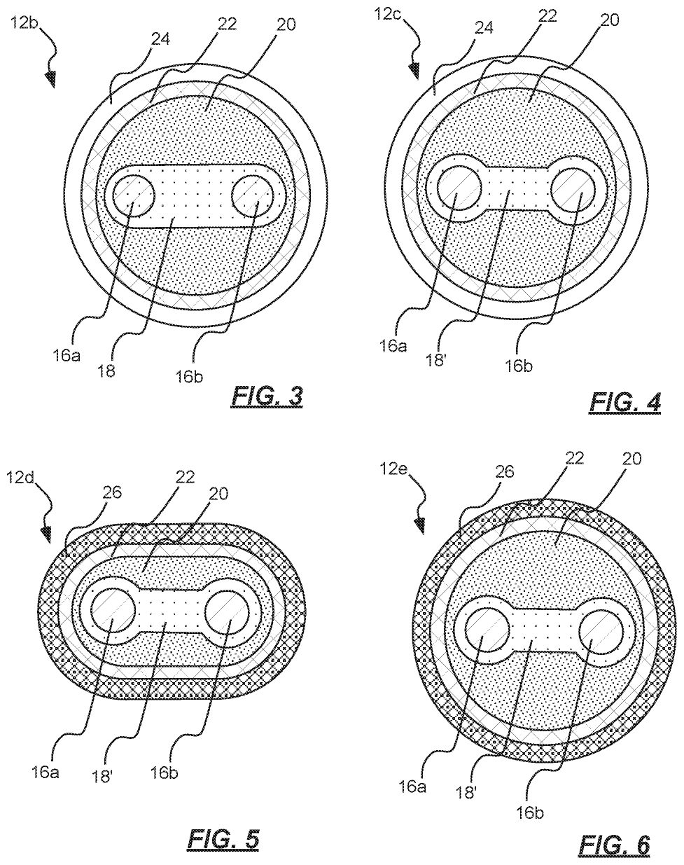

FIGS. 3 and 4 show similar cable configurations 12b, 12c, respectively, in a round overall cross section. As shown in FIG. 4, the overall round configuration can also include a PTC matrix with a reduced cross section. FIGS. 5 and 6 show embodiments 12d, 12e, respectively, that include a secondary, or outer compressible insulator 26 surrounding or encapsulating the metallic shield 22. This secondary, or outer, compressible insulator can allow even further expansion of the self-regulating heating cable 12d, 12e within a rigid outer casing (not shown in these figures).

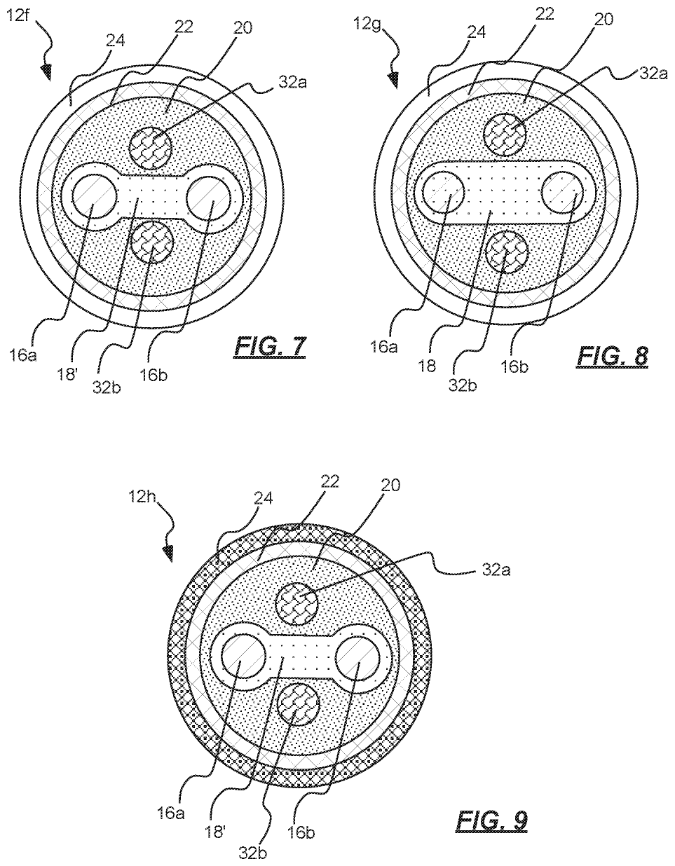

FIGS. 7 through 9 illustrates further embodiments of the invention in which a filler material, shown by example at 32a, 32b, can be disposed or embedded within the compressible insulator 20. The filler material can be formed from or include a variety of materials, including without limitation, paper fiber, rods of foam, yarn, natural and synthetic fibers, etc. As the filler material is generally much less expensive than the compressible insulator material, use of the filler material can allow variations in design to provide a cable with desired functional properties in any given geometric configuration.

In the examples shown, the first 16a and second 16b metallic conductors are substantially fully embedded in the PTC matrix 18, 18′. It is to be understood, however, that some configurations of the components may result in the PTC matrix being only partially abutted against the first and/or second conductors, so long as the conductors and PTC matrix are electrically coupled to one another. Similarly, in the examples shown, the compressible insulator 20 is generally fully encased by the outer insulating layer 24 and/or the metallic shield 22. The disclosure herein is intended to encompass configurations in which the various components are only partially encased by one another, or abut one another.

The compressible insulator 20, 26, etc., is illustrated in the figures as a generally unitary layer. However, this layer of material may itself be formed of differing constituent materials arranged in a matrix, arranged in an overlapping configuration, or arranged in a layered configuration. For example, the compressible insulator may be formed as a composite of one or more layers of a foam-like material and one or more layers of a harder material. The components illustrated in the figures may not be shown to scale. As one non-limiting example, the metallic shield 22 in FIG. 1 may have a thinner dimension than outer insulator 24. The compressible insulator 20 in particular may deviate in dimension and shape from that shown.

In addition to the structure discussed above, the present technology also provides various methods of forming, installing and operating self-regulating heating cables within a surface. For example, the technology can include a method of installing a heating cable, including obtaining a self-regulating heating cable having: a first metallic conductor; at least a second metallic conductor, spaced from and extending substantially parallel to the first metallic conductor; a PTC (positive temperature coefficient) matrix electrically coupled about the first and second metallic conductors; and a compressible insulator disposed about the PTC matrix, the compressible insulator being compressible to allow thermal expansion of the PTC matrix. The method can include embedding the self-regulating heating cable within a rigid, outer encasement material, the outer encasement material preventing outward expansion of the self-regulating heating cable. The method can include arranging the self-regulating heating cable in a pattern on a substrate prior to embedding the self-regulating heating cable within the rigid, outer encasement material. The rigid, outer encasement material can comprise a flowable material. The flowable material can include, for example, a cementitious material that flows when in an uncured state, then hardens into a rigid material when cured.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the examples.

I claim:

1. A heating cable, comprising:
a first metallic conductor;
at least a second metallic conductor, spaced from and extending substantially parallel to the first metallic conductor;
a PTC (positive temperature coefficient) matrix electrically coupled about the first and second metallic conductors;
a compressible insulator disposed about the PTC matrix, the compressible insulator being compressible to allow thermal expansion of the PTC matrix; and
an outer insulating layer disposed about the compressible insulator.

2. The heating cable of claim 1, wherein the compressible insulator includes at least one of: a foamed or cellular polymeric material, polyolefins, crosslinked polyolefins, fluoropolymers and thermoplastic elastomers.

3. The heating cable of claim 1, further comprising a metallic shield disposed about the compressible insulator.

4. The heating cable of claim 3, further comprising an outer compressible insulator substantially encasing the metallic shield.

5. The heating cable of claim 1, further comprising a filler material disposed within the compressible insulator.

6. The heating cable of claim 1, wherein the first and second metallic conductors are fully embedded in the PTC matrix.

7. The heating cable of claim 1, wherein the compressible insulator is fully encased by the outer insulating layer.

8. A heating cable installation, comprising:
a heating cable, including:
a first metallic conductor;
at least a second metallic conductor, spaced from and extending substantially parallel to the first metallic conductor;
a PTC (positive temperature coefficient) matrix electrically coupled about the first and second metallic conductors;
a compressible insulator disposed about the PTC matrix, the compressible insulator being compressible to allow thermal expansion of the PTC matrix; and
a rigid, outer encasement material, the outer encasement material preventing outward expansion of the heating cable.

9. The installation of claim 8, further comprising an outer insulating layer disposed about the compressible insulator.

10. The installation of claim 9, wherein the compressible insulator is fully encased by the outer insulating layer.

11. The installation of claim 8, wherein the compressible insulator includes at least one of: a foamed or cellular polymeric material, polyolefins, crosslinked polyolefins, fluoropolymers and thermoplastic elastomers.

12. The installation of claim 8, further comprising a metallic ground shield disposed about the compressible insulator.

13. The installation of claim 12, further comprising an outer compressible insulator substantially encasing the metallic ground shield.

14. The installation of claim 8, further comprising a filler material disposed within the compressible insulation material.

15. The installation of claim 8, wherein the first and second metallic conductors are fully embedded in the PTC composition.

16. A method of installing a heating cable, comprising:
obtaining a heating cable, the heating cable including:
a first metallic conductor;
at least a second metallic conductor, spaced from and extending substantially parallel to the first metallic conductor;
a PTC (positive temperature coefficient) matrix electrically coupled about the first and second metallic conductors;
a compressible insulator disposed about the PTC matrix, the compressible insulator being compressible to allow thermal expansion of the PTC matrix;
and
embedding the heating cable within a rigid, outer encasement material, the outer encasement material preventing outward expansion of the heating cable.

17. The method of claim 16, wherein the heating cable further comprises an outer compressible insulator substantially encasing the compressible insulator.

18. The method of claim 16, further comprising arranging the heating cable in a pattern on a substrate prior to embedding the heating cable within the rigid, outer encasement material.

19. The method of claim 16, wherein the rigid, outer encasement material comprises a flowable material.

20. The method of claim 19, wherein the flowable material includes a cementitious material.
